(19) United States
(12) Patent Application Publication
(10) Pub. No.: US 2025/0062375 A1
(43) Pub. Date: Feb. 20, 2025

(54) A METHOD FOR OPERATING A FUEL CELL

(71) Applicant: Volvo Truck Corporation, GÖTEBORG (SE)

(72) Inventors: Johan LINDBERG, Göteborg (SE); Pranav ARYA, Lindome (SE); Staffan LUONG, Borås (SE); Fredrik BLOMGREN, Hisings Kärra (SE)

(21) Appl. No.: 18/719,368

(22) PCT Filed: Dec. 15, 2021
(86) PCT No.: PCT/EP2021/085867

§ 371 Date: Jun. 13, 2024

(51) Int. Cl. H01M 8/04701; B60L 50/70; B60L 58/33; H01M 8/0432; H01M 8/0438; H01M 8/04537; H01M 8/04746; H01M 8/04955

(52) U.S. Cl. CPC H01M 8/04723; B60L 58/33; H01M 8/04365; H01M 8/04395; H01M 8/04552; H01M 8/04611; H01M 8/04753; B60L 50/70; H01M 8/04955; H01M 2250/20

(57) ABSTRACT

A method for operating a fuel cell system below a predetermined maximum polarisation cell voltage limit wherein, for each set of one or more operational conditions of the fuel cell, said limit corresponds to a minimum power limit, and wherein said set includes at least the temperature of the fuel cell, said method including: receiving a power request for execution at an execution time, in response to detecting that the power request is lower than an estimated minimum power limit corresponding to an estimated set of operational conditions at said execution time, including an estimated temperature, performing an adjustment of least one out of said operational conditions to achieve an adjusted set of operational conditions at which the minimum power limit is lower than said estimated minimum power limit; wherein said adjustment includes cooling said fuel cell to a reduced temperature being lower than said estimated temperature.

### TECHNICAL FIELD

The invention relates to a method for operating a fuel cell comprising one or more fuel cells. The invention also relates to a fuel cell system comprising one or more fuel cells and a cooling system with a cooling fluid for cooling the one or more fuel cells during use. The invention also relates to a control unit, a vehicle, a computer program and to a computer readable medium.

The invention can be applied in heavy-duty vehicles, such as trucks, buses and construction equipment. Although the invention will be described with respect to a truck, the invention is not restricted to this particular vehicle, but may also be used in other vehicles such as passenger cars.

### BACKGROUND

A fuel cell is an electrochemical cell which converts chemical energy into electricity. The fuel cell converts the chemical energy of a fuel, typically hydrogen, and an oxidizing agent, typically oxygen, into electricity. Typically, a plurality of fuel cells is arranged in a fuel cell system for generating power.

Accordingly, a fuel cell system can be used as an alternative or as a complement to electric batteries. In recent years fuel cell systems have been considered for powering electric vehicles, such as pure electric vehicles and hybrid electric vehicles.

When a fuel cell system operates at low current densities, the polarisation cell voltage of the fuel cells increases, which in turn has a negative impact on the durability of the fuel cells. To save the fuel cells from degradation, an operational maximum polarisation cell voltage is set, meaning in practice that the lowest operational power of the fuel cells is limited.

However, in certain applications such as for some driving scenarios when the fuel cell system is used to power a vehicle, it is desired to use the fuel cell system at an operation power being lower than this limit.

One present solution to this problem is to shut down the fuel cell system, and to instead utilise other power sources such as batteries so as to provide the requested low power. Another present solution is to allow the fuel cell to continue operating at a higher power than the requested low power, but to utilise the non-required excess power to charge the batteries of the vehicle. However, this solution requires that the batteries are available to take up the excess energy.

Therefore, there is a strive to develop alternative and/or improved fuel cell related technology which takes at least some of the above concerns into account.

### SUMMARY

An object of the invention is to provide a method for operating a fuel cell which provides an alternative and/or an improvement in relation to the prior art. In addition, an object of the invention is to provide a method for operating a fuel cell which enables operation at relatively low operational power of the fuel cell. Yet further objects of the invention are to provide a control unit for operating a fuel cell, a fuel cell system, a vehicle, and a computer program and/or computer readable medium.

According to a first aspect of the invention, at least one of the objects is achieved by a method according to claim 1.

Thus, a method for operating a fuel cell system comprising one or more fuel cells below a predetermined maximum polarisation cell voltage limit is provided, wherein, for each set of one or more operational conditions of the fuel cell system, the predetermined maximum polarisation cell voltage limit corresponds to a minimum power request limit, and wherein the set of one or more operational conditions comprises at least the temperature of the fuel cell. The method comprises:
receiving a power request for execution at an execution time,
in response to detecting that the power request is lower than an estimated minimum power limit corresponding to an estimated set of one more operational conditions at the execution time, the estimated set comprising an estimated temperature,
performing an adjustment of least one out of the one or more operational conditions to achieve an adjusted set of operational conditions at which the minimum power limit is lower than the estimated minimum power limit; wherein
the adjustment comprises cooling the fuel cell to a reduced temperature being lower than the estimated temperature.

By the provision of a method as disclosed herein, an improved method is achieved in which the minimum power limit may be reduced while maintaining a predetermined maximum polarisation cell voltage limit. For example, the method is based on a realization that by cooling the fuel cell to a reduced temperature as compared to an estimated temperature obtained if no additional cooling is performed, the minimum power limit may be reduced as compared to an estimated minimum power limit obtained if no additional cooling is performed, while remaining below the predetermined maximum polarisation cell voltage limit. Thus, relatively low power operation of the fuel cell(s) may be obtained without increase of the maximum polarisation cell voltage and hence without risking increased degradation of the fuel cell(s).

The set of operational conditions may comprise for example the air supply pressure, the hydrogen pressure, the relative humidity of the air and/or hydrogen, the air stochiometry ratio, the hydrogen stoichiometry ratio, and/or the coolant pressure.

The adjustment of one or more operational conditions is performed to achieve an adjusted set of operational conditions at which the minimum power limit is lower than if no adjustment was made, i.e. than an estimated minimum power limit without the adjustment.

Optionally, the method comprises performing the adjustment of at least one out of the one or more operational conditions to achieve an adjusted set of operational conditions at which the minimum power limit is lower than or equal to the power request, and
supplying power in accordance with the power request.

Optionally, the adjustment comprises cooling the fuel cell to a target temperature being the reduced temperature.

As such, the adjustment may comprise cooling the fuel cell(s) to a target temperature being the reduced temperature, while the remainder of the one or more operational conditions in the adjusted set are adjusted so as to enable operation of the fuel cell at the target temperature.

Further, the target temperature may be a temperature at which the minimum power limit is lower than or equal to the power request. Thus, the method may comprise cooling the fuel cell(s) to a target temperature at which the minimum power limit is lower than or equal to the power request, and supplying power in accordance with the power request.

Optionally, the set of one or more operational conditions comprises the air pressure to the fuel cell(s), and the adjustment comprises reducing the air pressure to a reduced air pressure being lower than an estimated air pressure of the estimated set of operational conditions.

This step relies on the realisation that by reducing the air pressure as compared to an estimated air pressure obtained if no adjustment is performed, the minimum power limit may be further reduced as compared to an estimated minimum power limit obtained if no adjustment is performed, while remaining below the predetermined maximum polarisation cell voltage limit. Thus, by the combined measures of reducing the temperature and reducing the air pressure, the minimum power limit may be further reduced.

For example, the adjustment may comprise reducing the air pressure to a target pressure being the reduced air pressure.

Optionally, the adjustment comprises cooling the fuel cell to the target temperature and/or reducing the air pressure to the target air pressure while the remainder of the one or more operational conditions in the adjusted set are adjusted so as to enable operation at the target temperature and/or target air pressure.

Optionally, the adjustment comprises a first stage wherein the adjustment comprises cooling the fuel cell to the target temperature while the remainder of the one or more operational conditions of the set are adjusted to enable operation at the target temperature, and a second stage wherein the adjustment comprises reducing the air pressure of the fuel cell to the target air pressure while the remainder of the one or more operational conditions of the set are adjusted to enable operation at the target air pressure, the first stage being performed before the second stage.

Thus, depending on the power request, the method may involve cooling or cooling followed by reduced air pressure, so as to enable providing power in accordance with the power request.

As mentioned in the above, the estimated temperature and/or the estimated air pressure are the temperature and air pressure which is estimated to occur if no adjustment of the set of operational parameters for the purpose of lowering the minimum power limit is made.

For example, the estimated temperature and/or estimated air pressure may be a nominal temperature and/or a nominal air pressure of the fuel cell.

Optionally, the estimated temperature and/or estimated air pressure is/are estimated based on predicted fuel cell operational conditions at the execution time. Thus, the predicted fuel cell operational conditions are the operational conditions predicted if no adjustment for the purpose of lowering the minimum power request limit is made. The execution time of the power request may in this case be a point of time in the future.

Yet optionally, the estimated temperature and/or estimated air pressure is/are a current fuel cell temperature and/or a current air pressure when receiving the power request.

When, as mentioned in the above, the method comprises supplying power in accordance with the power request, the method may further comprise performing a readjustment of the adjusted set of one or more operational conditions to achieve a readjusted set of operational conditions at which the minimum power limit is higher than or equal to the minimum power limit of the adjusted set. Hence, after supplying power in accordance with the power request, the set of operational conditions may be readjusted to resume operation having a higher minimum power limit, for example with a nominal minimum power limit of the fuel cell. For example, the readjustment of the set of operational conditions may involve allowing the fuel cell(s) to resume an increased temperature after the cooling thereof, and/or increasing the air pressure. For example, the readjustment may comprise restoring a nominal set of operational conditions, for example a nominal temperature and/or a nominal air pressure.

According to a second aspect of the invention, at least one of the objects is achieved by a control unit according to claim 12.

Thus, a control unit for operating a fuel cell comprising one or more fuel cells and a cooling system for cooling the one or more fuel cells during use is provided. The control unit is configured to perform the method according to any one of the embodiments of the first aspect of the invention.

Advantages and effects of the second aspect of the invention are largely analogous to the advantages and effects of the first aspect of the invention.

According to a third aspect of the invention, at least one of the objects is achieved by a fuel cell system according to claim 13.

Thus, a fuel cell system comprising one or more fuel cells and a cooling system for cooling the one or more fuel cells during use is provided. The fuel cell further comprises a control unit according to any one of the embodiments of the second aspect of the invention.

Advantages and effects of the third aspect of the invention are largely analogous to the advantages and effects of the first and second aspects of the invention. Furthermore, all embodiments of the third aspect of the invention are combinable with all embodiments of the first and second aspects of the invention, and vice versa.

Optionally, the fuel cell system may further comprise a temperature sensor for measuring a temperature indicative of the temperature of the one or more fuel cells. For example, the temperature sensor may be a temperature sensor which measures the temperature of a cooling fluid of the cooling system, such as the temperature of the cooling fluid downstream the one or more fuel cells, such as downstream a heat exchanger for the one or more fuel cells, e.g. directly after the cooling fluid has passed the one or more fuel cells and/or the heat exchanger for the one or more fuel cells. Additionally, or alternatively, a temperature sensor may also be provided upstream the one or more fuel cells, such as upstream a heat exchanger for the one or more fuel cells, such as just before the cooling fluid enters the one or more fuel cells and/or the heat exchanger for the one or more fuel cells. Additionally, or alternatively, a temperature sensor may also be provided directly on a heat exchanger for the one or more fuel cells, or at any other location close to or inside the one or more fuel cells.

According to a fourth aspect of the invention, at least one of the objects is achieved by a vehicle according to claim 14.

Thus, a vehicle comprising the fuel cell system according to any one of the embodiments of the third aspect of the invention and/or being in communication with a control unit according to any one of the embodiments of the second aspect of the invention is provided.

Advantages and effects of the fourth aspect are largely analogous to the advantages and effects of the first, second and third aspects of the invention. Furthermore, all embodiments of the fourth aspect of the invention are combinable with all embodiments of the first, second and third aspects of the invention, and vice versa.

According to a fifth aspect of the invention, at least one of the objects is achieved by a computer program according to claim 15.

Thus, a computer program comprising program code means for performing the method of any one of the embodiments of the first aspect of the invention when the program is run on the control unit of any one of the embodiments of the second aspect of the invention is provided.

According to a sixth aspect of the invention, at least one of the objects is achieved by a computer readable medium according to claim 16.

Thus, a computer readable medium carrying a computer program comprising program code means for performing the method of any one of the embodiments of the first aspect of the invention when the program product is run on the control unit of any one of the embodiments of the second aspect of the invention is provided.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a vehicle according to an example embodiment of the invention,

FIG. 2 is a schematic view of fuel cell system according to an example embodiment of the invention,

FIG. 3 is a flowchart of a method according to an example embodiment of the present invention,

FIG. 4 is a flowchart of a method according to an example embodiment of the invention, and

FIG. 5 is a diagram illustrating the polarisation cell voltage as a function of fuel cell power for various temperatures and air pressures of an example fuel cell system.

### DETAILED DESCRIPTION OF EXAMPLE EMBODIMENTS OF THE INVENTION

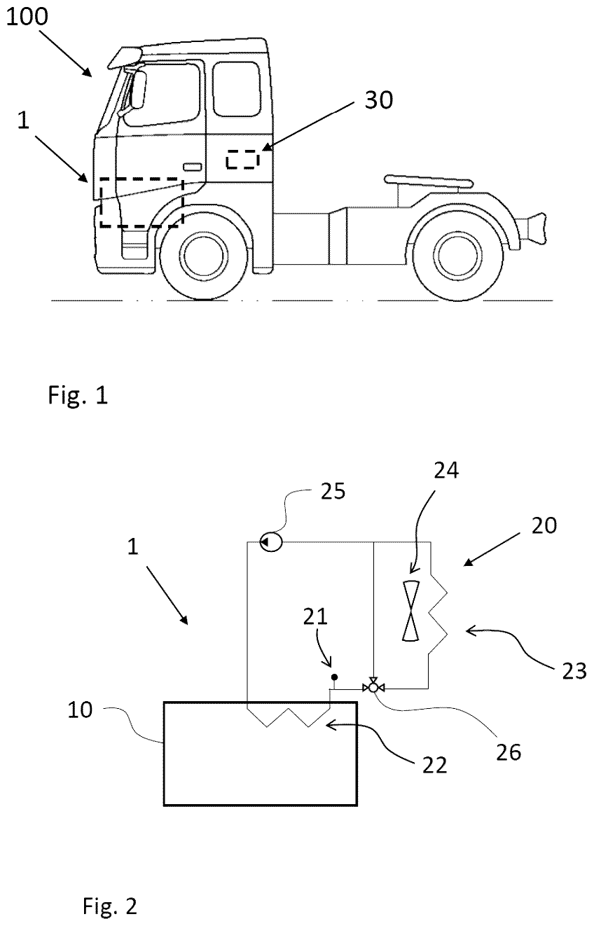

FIG. 1 depicts a side view of a vehicle 100 according to an example embodiment of the invention. The vehicle 100 is here a truck, more specifically a heavy-duty truck for towing one or more trailers (not shown). Even though a heavy-duty truck 100 is shown it shall be noted that the invention is not limited to this type of vehicle but may be used for any other type of vehicle, such as a bus, construction equipment, e.g. a wheel loader and an excavator, and a passenger car. The invention is also applicable for other applications not relating to vehicles as long as a fuel cell is utilized. However, the invention has shown to be particularly advantageous for vehicles since vehicles may occasionally require low power mode operation.

The vehicle 100 comprises a fuel cell system 1 according to an example embodiment of the invention. The fuel cell system 1 is here used for powering one or more electric motors (not shown) which are used for creating a propulsion force to the vehicle 100. The fuel cell system 1 may additionally or alternatively be used for powering other electric power consumers of the vehicle, such as an electric motor for a refrigerator system, an electric motor for an air conditioning system or any other electric power consuming function of the vehicle 100.

The vehicle 100 further comprises a control unit 30 according to an example embodiment of the invention. The control unit 30 is thus used for operating the fuel cell system 1. Even though an on-board control unit 30 is shown, it shall be understood that the control unit 30 could also be a remote control unit 30, i.e. an off-board control unit, or a combination of an on-board and off-board control unit. The control unit 30 may be configured to control the fuel cell system 1 by issuing control signals and by receiving status information relating to the fuel cell system 1.

The control unit 30 is an electronic control unit and may comprise processing circuitry which is adapted to run a computer program as disclosed herein. The control unit 30 may comprise hardware and/or software for performing the method according to the invention. In an embodiment the control unit 30 may be denoted a computer. The control unit 30 may be constituted by one or more separate sub-control units. In addition, the control unit 30 may communicate by use of wired and/or wireless communication means.

FIG. 2 depicts a schematic illustration of a fuel cell system 1 according to an example embodiment of the invention. The fuel cell system 1 may for example be used in the vehicle 100 as shown in FIG. 1.

The fuel cell system 1 comprises one or more fuel cells 10, typically several fuel cells. The fuel cells 10 may also be denoted as a fuel cell stack, wherein the fuel cell stack may comprise several hundreds of fuel cells. Further, the fuel cell system 1 will be arranged to provide the fuel cell 10 with necessary supply of hydrogen and air. Further the fuel cell system 1 comprises a cooling system 20. For example, and as illustrated in FIG. 2, the cooling system 20 may be a cooling system with a cooling fluid for cooling the one or more fuel cells 10 during use. In addition, the fuel cell system 1 may further comprise a control unit (not shown in FIG. 2) which is configured to perform a method according to an embodiment of the invention. The control unit may be the control unit 30 shown in FIG. 1.

As shown, the cooling system 20 as exemplified in FIG. 2 may comprise a heat exchanger 22 which is provided at the one or more fuel cells 10 and adapted to transfer heat from the one or more fuel cells 10 to the cooling fluid. The cooling system 20 as shown further comprises an additional heat exchanger 23, or radiator, and a fan 24 for blowing air over the heat exchanger 23, thereby cooling the cooling fluid. The cooling system 20 further comprises a pump 25 for pumping the cooling fluid, in the shown embodiment in a counter-clockwise direction. In addition, as shown, the cooling system 20 may comprise at least one valve 26, such as a bypass valve, arranged to bypass the cooling fluid with respect to the additional heat exchanger 23. The pump 25, the valve 26 and the fan 24 are controlled by the aforementioned control unit for operating the cooling system 20.

Optionally, and as shown in FIG. 2, the fuel cell system 1 may further comprise a temperature sensor 21 for measuring a temperature indicative of the temperature of the one or more fuel cells 10. In the shown embodiment, the temperature sensor 21 is located downstream the heat exchanger 22 and upstream the valve 26. It shall however be understood that a temperature sensor could additionally or alternatively be located somewhere else in the fuel cell system 1 as long it can measure a temperature which is indicative of the temperature of the one or more fuel cells 10.

Further, in addition or alternative to what is mentioned in the above, the fuel cell system 1 may comprise various components such as compressors, sensors, pumps, valves and electrical components.

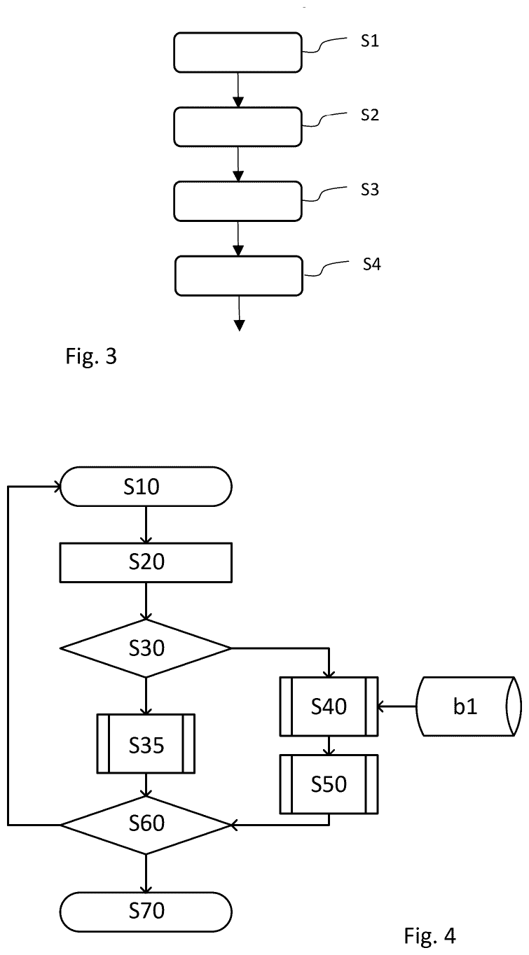

FIG. 3 depicts a flowchart of a method according to an example embodiment of the invention. Thus, the flowchart represents a method for operating a fuel cell system 1 comprising one or more fuel cells 10. The method comprises:
S1) receiving a power request for execution at an execution time;
S2) in response to detecting that the power request is lower than an estimated minimum power limit corresponding to an estimated set of one or more operational conditions at the execution time, the estimated set comprising an estimated temperature (S2);
S3) performing an adjustment of least one out of the one or more operational conditions to achieve an adjusted set of operational conditions at which the minimum power limit is lower than the estimated minimum power limit; wherein
   the adjustment comprises cooling the fuel cell(s) 10 to a reduced temperature being lower than the estimated temperature.

The power request may for example be a request from an operator, e.g. a driver of the vehicle 100. The power request may additionally or alternatively be provided from a vehicle control system, such as for controlling the vehicle e.g. during an idling situation, standing still in a traffic congestion, or going downhill.

The cooling of the fuel cell(s) 10 may for example be executed by operating a cooling system 20 so as to reduce the temperature of the one or more fuel cells 10.

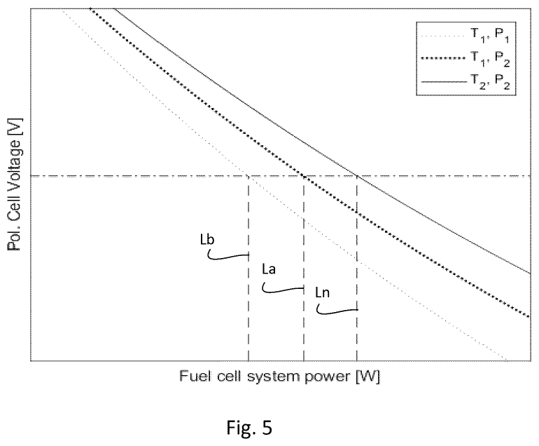

FIG. 5 depicts a diagram, or graph, illustrating the polarization cell voltage (V) as a function of the fuel cell system power (W). As shown, the polarization cell voltage (V) is represented along a y-axis and the fuel cell system power (W) is represented along an x-axis. Each curve in the diagram represents a different set of operational conditions of the fuel cell(s) 10. As shown in FIG. 5, for each set of operational conditions, the polarization cell voltage (V) is highest at lowest fuel cell system power being provided by the fuel cell(s), and decreases with increasing fuel cell system power.

The polarisation cell voltage as a function of the fuel cell system power may vary between different fuel cells and may for example be obtained by empirical tests.

To spare the fuel cell(s) 10 from degradation, it is desired to operate the fuel cell(s) 10 below a predetermined maximum polarisation cell voltage limit. In FIG. 5, such a predetermined maximum polarisation cell voltage limit is illustrated by a dash-dotted horizontal line. The value of the predetermined maximum polarisation cell voltage limit may be set at any value depending on e.g. the design of the fuel cell system 1 and/or its intended use. As seen in FIG. 5, for each set of operational conditions, the limitation to operation below the predetermined maximum polarisation cell voltage limit implies a limitation to operation above a resulting minimum fuel cell system power, indicated with vertical dashed lines in the drawings.

In FIG. 5, the uppermost curve, indicated with a solid line, represents a set of nominal operational conditions for a fuel cell 10. The minimum fuel cell system power limit Ln which may be obtained with the nominal operational conditions and without exceeding the predetermined maximum polarisation cell voltage limit is shown by the intersection point of the topmost curve with the maximum polarization cell voltage.

Now, for a fuel cell 10 operating with the nominal set of operational conditions, and in accordance with the method suggested herein, in response to detecting that a received power request is lower than the minimum fuel cell system power limit at the nominal conditions, an adjustment of at least one out of the operational conditions is performed, which adjustment comprises cooling the fuel cell 10 to a reduced temperature being lower than the nominal temperature.

The result of cooling the fuel cell 10 to a reduced temperature is that the polarisation cell voltage curve is moved down in comparison to the one with nominal conditions as illustrated in FIG. 5. In FIG. 5, the polarisation cell voltage curve indicated with a thick dotted line represents when the fuel cell 10 is run with a set of operational conditions wherein the temperature of the fuel cell 10 is reduced as compared to the nominal temperature of the fuel cell 10 . . . . As seen in FIG. 5, the minimum fuel cell power limit La when the fuel cell 10 is operating with the reduced temperature (thick dotted line) is lower than the minimum fuel cell power limit Ln when the fuel cell is operating with the nominal temperature (solid line).

It will be understood, that also other operational conditions in addition to the temperature may be adjusted simultaneously as the adjustment of the temperature, to achieve the effect of moving the curve as explained in the above.

For control of the fuel cell(s) 10, it may be advantageous to cool the fuel cell(s) 10 to a target temperature being the reduced temperature, while the remainder of the one or more operational conditions in the adjusted set are adjusted so as to enable operation of the fuel cell(s) 10 at the target temperature.

For example, and as illustrated in FIG. 5, although some of the one or more operational conditions in the adjusted set in addition to the temperature may be adjusted so as to enable operation of the fuel cell(s) 10 at the target temperature, other of the one or more operational conditions in the adjusted set may remain unadjusted as compared to the nominal situation. For example, and as in the example of FIG. 5, the air pressure may remain unadjusted while the temperature is adjusted.

When the adjusted set of operational conditions results in the new and lower minimum power limit being such that the power request may be executed, the method may comprise the step of supplying power in accordance with the power request (S4).

As will be understood from the above, the reduced temperature, e.g. the target temperature, may be selected depending on the power request so as to ensure that the adjusted set of operational conditions will allow the power request to be executed without exceeding the predetermined maximum polarisation cell voltage limit.

Further, the set of one or more operational conditions may comprise the air pressure to the fuel cell(s) 10, and the adjustment may comprise reducing the air pressure to a reduced air pressure being lower than an estimated air pressure of the estimated set of conditions.

In FIG. 5, the curve indicated with a thin dotted line is an example of operation with a second adjusted set of operational conditions including a reduced air pressure. In this example, the air pressure is reduced as compared to nominal set of operational conditions indicated with the solid line and as compared to the first adjusted set of operational conditions with the reduced temperature as indicated with the thick dotted line. The temperature is reduced as compared to the nominal set of operation conditions, but is similar to the reduced temperature of the first adjusted set of operational conditions. Thus, by reducing the air pressure in addition to reducing the temperature the curve is moved even further down as compared to the first adjusted set of operational conditions. Accordingly, and as may be seen in FIG. 5, the minimum fuel cell system power limit Lb is further lowered as compared to the limit La achieved when reducing the temperature but not the air pressure.

The method may comprise reducing the air pressure to a target air pressure being the reduced air pressure. As such, the method may comprise reducing the air pressure to a target air pressure while the remainder of the one or more operational conditions in the adjusted set are adjusted so as to enable operation at the target air pressure.

Optionally, the adjustment of the operational conditions may be performed in one or more stages. For example, the adjustment may comprise cooling the fuel cell(s) 10 to the target temperature while the remainder of the one or more operational conditions of the set are adjusted to enable operation at the target temperature, and a second stage wherein the adjustment comprises reducing the air pressure of the fuel cell(s) 10 to the target air pressure while the remainder of the one or more operational conditions of the set are adjusted to enable operation at the target air pressure, the first stage being performed before the second stage. Turning to the example of FIG. 5, the first stage corresponds to moving from the set of nominal operational conditions indicated with a solid line to a first set of adjusted operational conditions comprising reducing the temperature to a target temperature, thus moving from the solid line curve in FIG. 5 to the thick dotted line curve. The second stage corresponds to moving from the first set of adjusted operational conditions comprising reducing the temperature to a target temperature to a second set of adjusted operational conditions comprising reducing the air pressure to a target air pressure, thus moving from the thick dotted line curve in FIG. 5 to the thin dotted line curve. Thus, as an effect of the first stage, the minimum power limit of the fuel cell system is decreased, moving from Ln to La as illustrated in FIG. 5, and as an effect of the second stage, the minimum power limit is further decreased, moving from La to Lb.

However, it will be understood that method steps as described in the above may be varied, for example, in some embodiments the adjustment steps may be performed in a different order, or, in some embodiments the adjustment steps may be performed simultaneously.

In the examples in connection with FIG. 5 in the above, the estimated temperature and/or estimated air pressure of the fuel cell(s) at the execution time when the power request is to be executed is/are a nominal temperature and/or a nominal air pressure of the fuel cell.

However, it is to be understood that the estimated temperature and/or estimated air pressure may be other than nominal values.

For example, the estimated temperature and/or estimated air pressure may be estimated based on predicted fuel cell operational conditions at the execution time.

Optionally, the estimated temperature and/or estimated air pressure is/are a current fuel cell temperature and/or a current air pressure when receiving the power request. For example, this may be the case when the power request is to be immediately executed, and/or when relatively stable operational conditions are envisaged until the power request is to be executed.

Once the power request has been executed, i.e. after supplying power in accordance with the power request, the method may comprise performing a readjustment of the adjusted set of one or more operational conditions to achieve a readjusted set of operational conditions at which the minimum power limit is higher than or equal to the minimum power limit of the adjusted set. Thus, the operational conditions may for example be readjusted to nominal conditions.

To control the temperature of the fuel cell(s) 10 as an operational condition, for example to control the temperature to a target temperature, various methods for measuring or estimating the temperature of the fuel cell may be used. To this end, one or more temperature sensors may be utilised to determine a value indicative of the temperature of the fuel cell(s) 10. Such a value could be measured at the fuel cell(s) 10, but it could alternatively be measured e.g. adjacent the fuel cell(s) 10, or upstream or downstream the fuel cell(s) 10 in a fluid flow indicative of the temperature. For example, the value indicative of the temperature of the fuel cell(s) 10 corresponds to a temperature of a cooling fluid in a cooling system 20 utilised to cool the fuel cell(s) 10 and measured adjacent the fuel cell(s) 10. As such, the temperature may be measured for example by the temperature sensor 21 shown in FIG. 2.

FIG. 4 shows an example embodiment of the invention.

The method as shown in FIG. 4 comprises:
S10—starting the fuel cell
S20—obtaining a fuel cell power request, and
S30—determining if the power request is below a minimum power limit of the fuel cell
If yes, the method continues with:
S40—cooling the fuel cell so as to decrease the temperature of the fuel cell to a reduced target temperature. For example, this step may comprise controlling a cooling system so as to decrease a temperature of a cooling fluid in the cooling system to a lower setpoint value. In this step, information regarding target temperatures and/or setpoint values may be received from a database, such as a database with different coolant temperatures corresponding to different minimum power limits for the fuel cell at b1. When the reduced target temperature is achieved or deemed to be achieved, the minimum power limit of the fuel cell(s) 10 may be reset to the minimum power limit corresponding to that reduced target temperature.

Thereafter, provided the new minimum power limit is lower than the fuel cell power request, the method goes on to:
S50—executing the power request, i.e. adjusting the current density of the fuel cell(s) 10 according to the power request.

If in S30 it is determined that the power request is not below a low power limit of the fuel cell, the system goes on to S35—executing the power request and then further to S60.

S60 determines whether the fuel cell(s) 10 shall continue operation or not. If yes, the method restarts at S10. If no, the method goes on to step S70—stopping operation of the fuel cell(s) 10.

It will be understood that additional and/or alternative steps may be envisaged, such as for example a step for determining if the target temperature has been reached. The estimated minimum power limit at the time of execution of the power request may comprise estimating the low power limit at some time in the future. Hence, such an estimated minimum power limit may for example be estimated based on information relevant for estimating the operational conditions of the fuel cell at the relevant time in the future. For example, the estimation may be based on at least one of the following information,
manual input from an operator, such as a driver;
traffic information relating to a vehicle in which the fuel cell is provided;
terrain information relating to a vehicle in which the fuel cell is provided;
map data relating to a vehicle in which the fuel cell is provided; and
historical vehicle and/or operator behavior data.

As set out in the above, in S40 the cooling system 20 is operated so as to reduce the temperature of the one or more fuel cells 10, such as to the above-mentioned target temperature. In an embodiment, this step may be performed by decreasing the setpoint temperature of a cooling fluid of the cooling system 20. In this case, when there is no need to reduce the temperature of the one or more fuel cells 10, the cooling system may operate at a nominal setpoint temperature of the cooling fluid of the cooling system.

It is to be understood that the present invention is not limited to the embodiments described above and illustrated in the drawings; rather, the skilled person will recognize that many changes and modifications may be made within the scope of the appended claims.

1. A method for operating a fuel cell system comprising one or more fuel cells below a predetermined maximum polarisation cell voltage limit wherein, for each set of one or more operational conditions of the one or more fuel cells, said predetermined maximum polarisation cell voltage limit corresponds to a minimum power limit, and wherein said set of one or more operational conditions comprises at least the temperature of the one or more fuel cells, said method comprising:
receiving a power request for execution at an execution time,
in response to detecting that the power request is lower than an estimated minimum power limit corresponding to an estimated set of one more operational conditions at said execution time, said estimated set comprising an estimated temperature,
performing an adjustment of least one out of said one or more operational conditions to achieve an adjusted set of operational conditions at which the minimum power limit is lower than said estimated minimum power limit; wherein
said adjustment comprises cooling said one or more fuel cells to a reduced temperature being lower than said estimated temperature.

2. The method according to claim 1, comprising performing said adjustment of at least one out of said one or more operational conditions to achieve an adjusted set of operational conditions at which the minimum power limit is lower than or equal to said power request, and
supplying power in accordance with the power request.

3. The method according to claim 1, wherein said adjustment comprises cooling said one or more fuel cells to a target temperature being said reduced temperature, while the remainder of the one or more operational conditions in said adjusted set are adjusted so as to enable operation of said fuel cell at said target temperature.

4. The method according to claim 1, wherein said set of one or more operational conditions comprises the air pressure to said fuel cell, and said adjustment comprises reducing the air pressure to a reduced air pressure being lower than an estimated air pressure of said estimated set of conditions.

5. The method according to claim 4, comprising reducing the air pressure to a target air pressure being said reduced air pressure.

6. The method according to claim 3, wherein said adjustment comprises cooling said one or more fuel cells to said target temperature and/or reducing the air pressure to said target air pressure while the remainder of the one or more operational conditions in said adjusted set are adjusted so as to enable operation at said target temperature and/or target air pressure.

7. The method according to claim 6, wherein the adjustment comprises a first stage wherein said adjustment comprises cooling said one or more fuel cells to said target temperature while the remainder of the one or more operational conditions of said set are adjusted to enable operation at said target temperature, and a second stage wherein said adjustment comprises reducing the air pressure of the one or more fuel cells to said target air pressure while the remainder of the one or more operational conditions of said set are adjusted to enable operation at said target air pressure, said first stage being performed before said second stage.

8. The method according to claim 1, wherein said estimated temperature and/or estimated air pressure is/are a nominal temperature and/or a nominal air pressure of the fuel cell(s).

9. The method according to claim 1, wherein said estimated temperature and/or estimated air pressure is/are estimated based on predicted fuel cell operational conditions at said execution time.

10. The method according to claim 1, wherein said estimated temperature and/or estimated air pressure is/are a current fuel cell temperature and/or a current air pressure when receiving said power request.

11. The method according to claim 2, further comprising, after supplying power in accordance with said power request:
Performing a readjustment of said adjusted set of one or more operational conditions to achieve a readjusted set of operational conditions at which the minimum power limit is higher than or equal to the minimum power limit of said adjusted set.

12. A control unit for operating a fuel cell system comprising one or more fuel cells and a cooling system for cooling the one or more fuel cells during use, wherein the control unit is configured to perform the method according to claim 1.

13. A fuel cell system comprising one or more fuel cells and a cooling system for cooling the one or more fuel cells, wherein the fuel system further comprises a control unit according to claim 12.

14. A vehicle comprising the fuel cell system according to claim 13.

15. A computer program comprising program code means for performing the method of claim 1 when said program is run on the control unit of claim 12.

16. A computer readable medium carrying a computer program comprising program code means for performing the method of claim 1.
